(19) United States
(12) Patent Application Publication
(10) Pub. No.: US 2014/0166938 A1
(43) Pub. Date: Jun. 19, 2014

(54) CONDUCTIVE POLYMER COMPOSITION HAVING HIGH VISCOSITY AND CONDUCTIVITY

(71) Applicant: Nuri Vista Co. Ltd., Seoul (KR)

(72) Inventors: Yong-Hyun JIN, Incheon (KR); Soon-Mo Song, Incheon (KR); Seong-Sil Park, Incheon (KR); Tae-Il Hwang, Ansan-si (KR); Hyun-Chul Jeong, Seoul (KR)

(73) Assignee: Nuri Vista Co. Ltd., Seoul (KR)

(21) Appl. No.: 13/899,880

(22) Filed: May 22, 2013

(30) Foreign Application Priority Data
Dec. 14, 2012 (KR) 10-2012-0146095

(51) Int. Cl. H01B 1/12

(52) U.S. Cl. CPC H01B 1/127
USPC 252/500

(57) ABSTRACT

The present invention relates to a conductive polymer composition having high viscosity and high conductivity, and more particularly, to a conductive polymer composition having excellent electrical conductivity and stability by adding a thixotropic agent, which is dissociated in an aqueous solution to generate negative charges, to PEDOT.

### CROSS-REFERENCE TO RELATED APPLICATION

This application claims the benefit under 35 U.S.C. §119 of Korean Patent Application No. 10-2012-0146095, filed on Dec. 14, 2012 in the Korean Intellectual Property Office, the entirety of which is incorporated herein by reference.

### BACKGROUND

1. Technical Field

The present invention relates to a conductive polymer composition having high viscosity and high conductivity, and more particularly, to a conductive polymer composition having excellent electrical conductivity, stability and printability by adding a thixotropic agent, which is dissociated in an aqueous solution to generate negative charges, to PEDOT.

2. Description of the Related Art

Conductive polymers are advantageous in that they are organic materials which conduct electricity. Recently, conductive polymers are applied to real life and advanced industrial fields, such as touch panels, flexible display devices, flexible transparent electrodes, electronic organizers, secondary batteries, static electricity prevention, switching devices, nonlinear elements, condensers, optical recording materials, electromagnetic shielding materials, and the like.

In order for a conductive polymer to exhibit conductivity, a doping process is needed. Typically, the process is performed by preparing a polymer in the form of a powder or film and chemically doping the powder or film, or by mixing the conductive powder with a dopant and dissolving the mixture in an organic solvent to provide conductivity.

Among various conductive polymers, poly(3,4-ethylenedioxythiophene):poly(4-styrenesulfonate) (PEDOT:PSS) disclosed in European Patent Publication No. 0440957 has been applied to various fields due to stability in air and higher electrical conductivity at room temperature than other polymers.

Particularly, a material prepared by doping PEDOT with poly(4-styrenesulfonate) (PSS) as a dopant is widely used as a material for electrodes or an antistatic material since it can be applied very evenly and has excellent interfacial properties and adhesion.

However, a conductive layer prepared from PEDOT:PSS has very low conductivity and transmittance, and thus is not enough to replace ITO for touchscreens or organic light emitting diodes. For example, an ITO layer has a conductivity of 5,000 S/cm or more, a transmittance of 90%, and a surface resistance of 5 to 20 Ω/sq.

In this regard, it was found that addition of dimethylsulfoxide (DMSO) to a PEDOT:PSS dispersion resulted in increase of conductivity up to 100 times. Since a transparent conductive film without haze can be prepared from dimethylsulfoxide, the dimethylsulfoxide is very suitable as an additive for increasing conductivity. However, such a transparent conductive film still has too low conductivity to replace ITO for touchscreens or organic light emitting diodes.

Further, there is a problem in that an aqueous solution of PEDOT:PSS cannot be used to form a uniform thin film due to poor resistance stability in liquid phase and thus poor coating properties.

Therefore, the inventors of the present invention have studied factors, which can affect electrical properties and resistance stability in liquid phase of the conductive polymer, PEDOT, and found that a thixotropic agent prevents water from entering PEDOT or PEDOT:PSS to allow the PEDOT or PEDOT:PSS to exhibit high viscosity, thereby providing excellent resistance stability and improved conductivity.

### BRIEF SUMMARY

Therefore, the present invention is aimed at providing a conductive polymer composition having excellent electrical conductivity, stability and printability by adding a thixotropic agent to PEDOT.

In accordance with one aspect, the present invention provides a conductive polymer composition, which includes: (a) an aqueous solution of a polythiophene-based conductive polymer; and (b) a thixotropic agent dissociated in the aqueous solution to generate negative charges.

The polythiophene-based conductive polymer (a) may be i) PEDOT (poly(3,4-ethylenedioxythiophene)) represented by Formula I, or ii) a mixture of the PEDOT and PS S (poly(4-styrenesulfonate)) represented by Formula II.

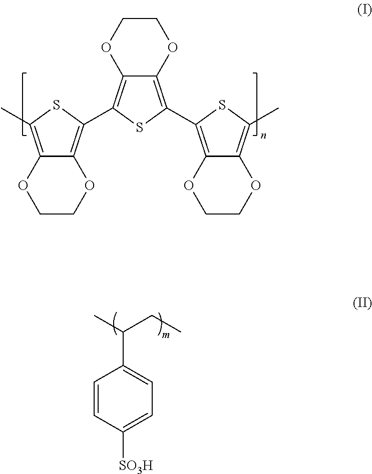

wherein n and m are independently an integer ranging from 5 to 10000.

The thixotropic agent may include a linear or cross-linked polyacrylic acid.

### DETAILED DESCRIPTION

The above and other aspects, features, and advantages of the present invention will become apparent from the detailed description of the following embodiments. However, it should be understood that the present invention is not limited to the following embodiments and may be embodied in different ways, and that the embodiments are provided for complete disclosure and thorough understanding of the present invention by those skilled in the art. The scope of the present invention will be defined only by the claims and equivalents thereof.

A conductive composition according to the present invention will now be described in more detail.

Conductive Polymer Composition

A conductive polymer composition according to the present invention includes: (a) an aqueous solution of a polythiophene-based conductive polymer, and (b) a thixotropic agent dissociated in the aqueous solution to generate negative charges.

The polythiophene-based conductive polymer (a) may be i) PEDOT (poly(3,4-ethylenedioxythiophene)) represented by Formula I, or ii) a mixture of the PEDOT and PSS (poly(4-styrenesulfonate)) represented by Formula II.

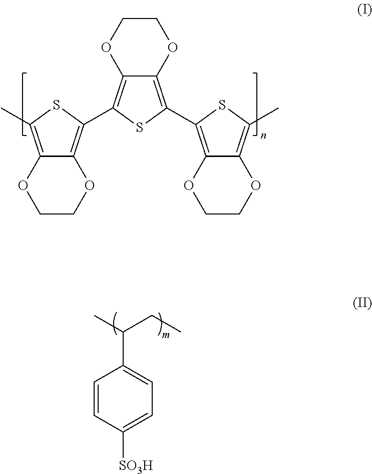

(wherein n and m are independently an integer ranging from 5 to 10000)

In the present invention, the polythiophene-based conductive polymer is an aromatic polymer, such as polythiol or polyaniline, and representatively PEDOT. The PEDOT may be used alone or in combination with PSS. PEDOT:PSS is most preferred.

The thixotropic agent (b) contained in the conductive polymer composition is dissociated in the aqueous solution and generates negative charges. In the present invention, the thixotropic agent (b) may be a linear or cross-linked polyacrylic acid.

The polyacrylic acid dissolved in water is dissociated into polymer ions and lower molecular weight ions to generate negative charges, whereby the polyacrylic acid can be maintained in a swollen state by van der Waals force between the negative charges. Thus, the polyacrylic acid may control rheological properties of PEDOT or PEDOT:PSS and provides thixotropy, thereby improving resistance stability in liquid phase and electrical conductivity.

The thixotropic agent such as the polyacrylic acid is different from a binding agent. The thixotropic agent swells due to generation of charges in a main chain thereof, thus exhibited increased viscosity together with increased specific surface, and permits reversible tangling or stretching of the main chain.

Unlike the thixotropic agent, a binding agent has viscosity which increases due to increase in specific surface area or no movement between chains by chemical bonding between the chains, and permits irreversible tangling or stretching of the main chain.

If the thixotropic agent swells due to charge generation, thus having an increased specific surface area such that the amount of effective charges of the polymer ions is increased, the lower molecular weight ions are attracted by the polymer ions and then fixed to the polymer. As a result, the amount of the effective charges of the polymer ions is reduced and electric repulsion between homogeneous ions is weakened, whereby there is a tendency to be deflected like a skein.

Consequently, the polymer ions reach an equilibrium state between stretching and tangling, and the specific surface area of polymer chains causes a reversible viscosity change

The thixotropic agent may be present in an amount of 0.00001 to 2 parts by weight, preferably 0.00001 to 1 parts by weight, based on 100 parts by weight of the aqueous solution of the polythiophene-based conductive polymer. If the amount of the thixotropic agent is less than 0.00001 parts by weight, it is difficult to obtain desired viscosity suitable for screen printing. If the amount of the thixotropic agent exceeds 2 parts by weight, the viscosity can be increased, but there are problems such as agglomeration of the conductive polymer, significant increase in surface resistance, particularly, variation in viscosity over time, and the like. Particularly, if the amount of the thixotropic agent exceeds 1 part by weight, there are problems of variation in viscosity over time and rapid change in conductivity.

The conductive polymer composition according to the present invention may further include a binding agent to increase binding force between chains of the polythiophene-based conductive polymer. Here, HPC (hydroxypropylcellulose) is preferred as the binding agent.

As described above, unlike the thixotropic agent, the binding agent, HPC, serves to increase viscosity while improving specific surface area through chemical bonding between chains.

The binding agent may be present in an amount of 0.001 to 10 parts by weight based on 100 parts by weight of the aqueous solution of the polythiophene-based conductive polymer. If the amount of the binding agent is below this range, the binding agent does not properly function in the conductive polymer. If the amount of the binding agent exceeds this range, the conductive polymer suffers from increase in surface resistance.

In addition, the conductive polymer composition according to the present invention may further include a cros slinking agent. The cros slinking agent may be selected from linear or cross-linked isocyanate compounds.

The crosslinking agent may be present in an amount of 0.00001 to 2 parts by weight based on 100 parts by weight of the aqueous solution of the polythiophene-based conductive polymer. If the amount of the cross-linking agent is below this range, there is a limit in increasing viscosity due to insufficient binding force. If the amount thereof exceeds this range, the conductive polymer suffers from increase in surface resistance.

The conductive polymer composition according to the present invention may further include a polar solvent. The polar solvent may include at least one selected from the group consisting of dimethylformamide (DMF), dimethylsulfoxide (DMSO), N-methyl-2-pyrrolidone (NMP), methyl alcohol, ethyl alcohol, isopropyl alcohol, propanol, butanol, 4-methylphenol, ethylene glycol, cyclohexanone, tetrahydrofuran (THF), N-nitromethane, toluene, propylene glycol monomethylether acetate, ethyl-3-ethoxypropionate and hexanol.

The polar solvent may be present in an amount of 2 to 30 parts by weight based on 100 parts by weight of the aqueous solution of the polythiophene-based conductive polymer. If the amount of the polar solvent is less than this range, there is a limit in functioning as a secondary dopant. If the amount of the polar solvent exceeds this range, there is a limit in improving electrical properties due to saturation of dopants.

### EXAMPLE

Hereinafter, the present invention will be described in detail with reference to examples. It should be understood that the scope of the present invention is not limited by these examples.

### Example 1

A common oxidizing agent and a polymer stabilizer were mixed with EDOT (3,4-ethylenedioxythiophene) in a certain ratio, and stirred at room temperature for 24 hours to perform emulsion polymerization, thereby preparing an aqueous solution of PEDOT:PSS.

DMSO was added to the prepared aqueous solution of PEDOT:PSS in an amount of 5 parts by weight based on 100 parts by weight of the aqueous solution of PEDOT:PSS to prepare a conductive polymer solution (A).

A linear polyacrylic acid was gradually added to the conductive polymer solution (A) in an amount of 0.00001 to 2 parts by weight based on 100 parts by weight of the conductive polymer aqueous solution to prepare a conductive polymer composition including a thixotropic agent.

### Example 2

A conductive polymer composition was prepared in the same manner as in Example 1, except that a cross-linked polyacrylic acid was used instead of the linear polyacrylic acid.

### Example 3

A conductive polymer composition was prepared in the same manner as in Example 1, except that 0.002 parts by weight of an HPC binder was further mixed with the conductive polymer composition.

### Example 4

A conductive polymer composition was prepared in the same manner as in Example 1, except that 0.0001 parts by weight of an isocyanate crosslinking agent was further mixed with the conductive polymer composition.

### Comparative Example

A common oxidizing agent and a polymer stabilizing agent were mixed with EDOT (3,4-ethylenedioxythiophene) in a certain ratio, and stirred at room temperature for 24 hours to perform emulsion polymerization, thereby preparing an aqueous solution of PEDOT:PSS.

DMSO was added to the prepared aqueous solution of PEDOT:PSS in an amount of 5 parts by weight based on 100 parts by weight of the aqueous solution of PEDOT:PSS to prepare a final conductive polymer solution.

### Experimental Example: Evaluation of Resistance and Viscosity

Each of the conductive polymer solutions prepared in the examples and the comparative example was coated on a PET film, followed by evaluation as to surface resistance and viscosity.

1. Resistance

For the conductive polymer compositions prepared in Examples 1 to 4, change in surface resistance according to the amount of the thixotropic agent was observed. In addition, change in surface resistance of the conductive polymer composition prepared in Comparative Example, which contained no thixotropic agent, was also observed. Results are shown in Table 1.

TABLE 1
Variation in Surface Resistance According to amount of thixotropic Agent (Unit: Ω/sq)

| Amount of | | | | | | | | | |
|---|---|---|---|---|---|---|---|---|---|
| thixotropic agent | | | | | | | | | |
| (Parts by Weight) | 1 × e⁻⁶ | 1 × e⁻⁵ | 1 × e⁻⁴ | 1 × e⁻³ | 1 × e⁻² | 1 × e⁻¹ | 1 × e⁰ | 1 × e¹ | 1 × e² |
| Example 1 | 300 | 310 | 320 | 330 | 340 | 350 | 500 | 800 | 1300 |
| Example 2 | 300 | 310 | 320 | 350 | 370 | 400 | 750 | 1100 | 2500 |
| Example 3 | 300 | 310 | 330 | 340 | 350 | 370 | 600 | 900 | 1500 |
| Example 4 | 400 | 420 | 440 | 500 | 700 | 900 | 1500 | 3200 | 5000 |
| Comparative | 270 | 270 | 270 | 270 | 270 | 270 | 270 | 270 | 270 |
| Example 1 | | | | | | | | | |

As shown in Table 1, it could be seen that the resistance was increased with increasing amount of the thixotropic agent in the examples and was rapidly increased at an amount of 1 part by weight or more, regardless of the type of thixotropic agent (linear or cross-linked) (comparing Examples 1 and 2).

Generally, preferred surface resistance of a conductive polymer composition for electric devices, particularly touch modules, ranges from 150 Ω/sq to 400 Ω/sq. Here, since the surface resistance of the conductive polymer significantly increases with increasing viscosity thereof, it is important to maintain stability of surface resistance.

As compared with Comparative Example, it could be seen that, although the surface resistance of the conductive polymer compositions prepared in the inventive examples increased with increasing viscosity due to the addition of the thixotropic agent, the conductive polymer compositions of the inventive examples had stability of surface resistance in a desirable range.

2. Viscosity

For the conductive polymer compositions prepared in Examples 1 to 4 and Comparative Example, change in viscosity according to the amount of the thixotropic agent was observed. Viscosity was measured using a Brookfield viscometer under conditions of 22° C., spindle: #4, speed: 10 rpm. Results are shown in Table 2.

TABLE 2
Change in Viscosity According to Amount of Thixotropic Agent (Unit: mPas)

| Amount of | | | | | | | | | |
|---|---|---|---|---|---|---|---|---|---|
| thixotropic agent | | | | | | | | | |
| (Parts by Weight) | 1 × e⁻⁶ | 1 × e⁻⁵ | 1 × e⁻⁴ | 1 × e⁻³ | 1 × e⁻² | 1 × e⁻¹ | 1 × e⁰ | 1 × e¹ | 1 × e² |
| Example 1 | 55 | 87 | 169 | 360 | 870 | 1270 | 5300 | 8700 | 16430 |
| Example 2 | 65 | 94 | 194 | 460 | 1020 | 1600 | 13000 | 32000 | 46000 |
| Example 3 | 85 | 158 | 410 | 950 | 1430 | 3100 | 11000 | 19900 | 30000 |
| Example 4 | 100 | 500 | 1000 | 2000 | 5000 | 10000 | 25000 | 50000 | 1000000 |
| Comparative | 30 | 30 | 30 | 30 | 30 | 30 | 30 | 30 | 30 |
| Example 1 | | | | | | | | | |

As shown in Table 2, it could be seen that the viscosity was increased with increasing amount of the thixotropic agent and was rapidly increased at an amount of 1 part by weight or more, regardless of the type of thixotropic agent (linear or cross-linked).

Particularly, as compared with Comparative Example, it could be confirmed that high viscosity was obtained by adding the thixotropic agent, and despite a significant increase in viscosity, resistance increase was effectively compensated for.

According to the present invention, the addition of a thixotropic agent to PEDOT or PEDOT:PSS results in thixotropy that provides rapid increase in viscosity in a static state and decrease in viscosity upon application of stress, thereby improving resistance stability in liquid phase and electrical conductivity.

In addition, according to the present invention, the addition of HPC to the PEDOT or PEDOT:PSS results in increase in binding force between chains of the PEDOT, thereby improving stability of a molecular structure and electrical conductivity.

Further, according to the present invention, increase in surface resistance due to viscosity increase can be effectively compensated using the thixotropic agent of the present invention. Furthermore, the conductive polymer composition prepared according to the present invention exhibits high viscosity and excellent printability, and thus can be suitably used for screen printing and a transparent electrode.

Although some exemplary embodiments have been described herein, it should be understood by those skilled in the art that these embodiments are given by way of illustration only, and that various modifications, variations and alterations can be made without departing from the spirit and scope of the present invention. Therefore, the scope of the present invention should be limited only by the accompanying claims and equivalents thereof.

What is claimed is:

1. A conductive polymer composition, comprising:
(a) an aqueous solution of a polythiophene-based conductive polymer; and
(b) a thixotropic agent dissociated in the aqueous solution to generate negative charges.

2. The conductive polymer composition according to claim 1, wherein the polythiophene-based conductive polymer (a) is
i) PEDOT (poly(3,4-ethylenedioxythiophene)) represented by Formula I, or
ii) a mixture of the PEDOT and PSS (poly(4-styrenesulfonate)) represented by Formula II. 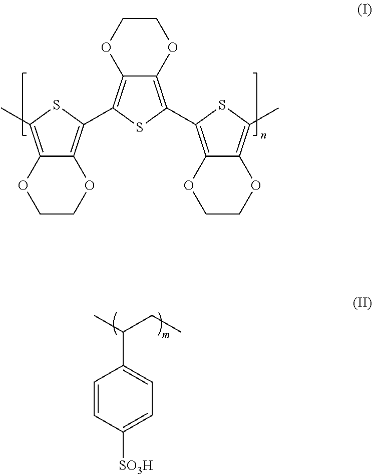
wherein n and m are independently an integer ranging from 5 to 10000.

3. The conductive polymer composition according to claim 1, wherein the thixotropic agent comprises a linear or cross-linked polyacrylic acid.

4. The conductive polymer composition according to claim 1, wherein the thixotropic agent is present in an amount of 0.00001 to 2 parts by weight based on 100 parts by weight of the aqueous solution of the polythiophene-based conductive polymer.

5. The conductive polymer composition according to claim 1, further comprising: a binding agent to increase binding force between chains of the polythiophene-based conductive polymer.

6. The conductive polymer composition according to claim 5, wherein the binding agent comprises hydroxypropylcellulose (HPC).

7. The conductive polymer composition according to claim 5, wherein the binding agent is present in an amount of 0.001 to 10 parts by weight based on 100 parts by weight of the aqueous solution of the polythiophene-based conductive polymer.

8. The conductive polymer composition according to claim 1, further comprising: a crosslinking agent.

9. The conductive polymer composition according to claim 8, wherein the crosslinking agent is selected from linear or cross-linked isocyanate compounds.

10. The conductive polymer composition according to claim 8, wherein the crosslinking agent is present in an amount of 0.00001 to 2 parts by weight based on 100 parts by weight of the aqueous solution of the polythiophene-based conductive polymer.

11. The conductive polymer composition according to claim 1, further comprising: a polar solvent.

12. The conductive polymer composition according to claim 11, wherein the polar solvent comprises at least one selected from the group consisting of dimethylformamide (DMF), dimethylsulfoxide (DMSO), N-methyl-2-pyrrolidone (NMP), methyl alcohol, ethyl alcohol, isopropyl alcohol, propanol, butanol, 4-methylphenol, ethylene glycol, cyclohexanone, tetrahydrofuran (THF), N-nitromethane, toluene, propylene glycol monomethylether acetate, ethyl-3-ethoxypropionate, and hexanol.

13. The conductive polymer composition according to claim 11, wherein the polar solvent is present in an amount of 2 to 30 parts by weight based on 100 parts by weight of the aqueous solution of the polythiophene-based conductive polymer.
